(19) United States
(12) Patent Application Publication
(10) Pub. No.: US 2009/0074162 A1
(43) Pub. Date: Mar. 19, 2009

(54) METHOD FOR INTEGRATING MARKETING WITH A COMMUNICATIONS SYSTEM

(75) Inventor: Rix Alan Ryskamp, Springville, UT (US)

Correspondence Address: Kunzler & McKenzie, 8 EAST BROADWAY, SUITE 600, SALT LAKE CITY, UT, 84111, US

(73) Assignee: Transcend Products, LLC, Provo, UT (US)

(21) Appl. No.: 12/210,911

(22) Filed: Sep. 15, 2008

Related U.S. Application Data
(60) Provisional application No. 60/993,851, filed on Sep. 14, 2007.

(51) Int. Cl. H04M 15/00

(52) U.S. Cl. 379/114.1

(57) ABSTRACT

A method is provided for integrating marketing with a communications system. Initially, the method may create an electronic directory with a plurality of directory records and group records. The method may include distributing a communication platform which interfaces with the electronic directory to a plurality of users. In addition, the method may include establishing, by way of the communication platform, one or more communication sessions for the plurality of users. Furthermore, the method may also include a sales person listed in the electronic directory managing a marketing channel by way of the communication platform. Finally, the method may include recruiting new users of the communication platform and new organization members by way of the communication platform. The communication platform may solicit for new users and new organization members in exchange for establishing communication sessions on the communication platform.

### CROSS-REFERENCES TO RELATED APPLICATIONS

This application claims the benefit of U.S. Provisional Patent Application No. 60/993,851 entitled “PROCESSES FOR COMBINING MARKETING AND TELECOMMUNICATIONS SYSTEMS” and filed on Sep. 14, 2007 for Rix Alan Ryskamp which is incorporated herein by reference.

### BACKGROUND OF THE INVENTION

1. Field of the Invention

This application relates to the field of methods for marketing products and electronic communications.

2. Description of the Related Art

As the communication capabilities of the World Wide Web increase, more and more companies turn to web technologies for their communication needs. One emerging communication system is Voice-over-Internet-Protocol (VoIP) technology which allows a user to communicate video and audio over the internet using a personal computer. In fact, some companies are able to use VoIP technologies for PC based phone services such as Skype™ and Session Initiation Protocol (SIP) soft phones to carry out most of the telephone calls of the company at little to no cost. However, many of these soft phone users continue to use other forms of communication, thus making the management of these many forms of communication difficult.

Furthermore, certain sales and marketing organizations, such as network marketing organizations (also known as multi-level marketing, direct sales, and person-to-person selling) rely on a complex network of individuals performing distribution, sales, recruiting, compensation, and management. Not only must network marketing distributors and managers perform these tasks, these individuals must maintain communication throughout the network in order to maximize the efficiency of the organization.

### SUMMARY OF THE INVENTION

The present invention has been developed to provide for facilitating management of a sales organization.

A method is presented for distributing a telecommunication platform to a plurality of users that accesses an electronic directory, establishing one or more telecommunication sessions for the plurality of users, a sales person listed in the electronic directory managing a marketing channel, and recruiting new users of the telecommunication platform and new organization members.

In one embodiment, the method includes distributing a telecommunication platform to a plurality of users. The method may also include creating an electronic directory in communication with the telecommunication platform, the electronic directory having a plurality of directory records and group records. Each directory record contains user information and indicates user group membership and one or more group leaders. This telecommunication platform may interface with the electronic directory. In addition, the method may include establishing, by way of the telecommunication platform, one or more telecommunication sessions for the plurality of users. The one or more telecommunication sessions may exchange electronic media, video, audio, electronic messages, and digital files.

Furthermore, the method may also include a sales person listed in the electronic directory managing a marketing channel by way of the telecommunication platform. The marketing channel may include at least one user of the plurality of users having a business relationship to the sales person. Finally, the method may include recruiting new users of the telecommunication platform and new organization members by way of the telecommunication platform. The telecommunication platform may solicit for new users and new organization members in exchange for establishing telecommunication sessions on the telecommunication platform free of charge.

In one embodiment, the method includes tracking usage of the telecommunication platform by the users. In this embodiment, the usage includes activating the telecommunication platform, establishing user telecommunication sessions, participating in a user telecommunication session, registering a user with the organization, and responding to a solicitation. In another embodiment, the method includes managing the electronic directory. Managing may include updating one or more of user information, group membership, and group leader designation. In certain embodiments, the method includes interfacing with a sales organization compensation system. In this embodiment, interfacing includes crediting a user in response to members of the marketing channel that belongs to the user using features of the telecommunication platform.

In one embodiment, the electronic directory includes a hierarchical tree structure representing a plurality of marketing channels for the sales organization. The hierarchical tree structure may include parent directory records and child directory records. In another embodiment, the method includes enabling user interaction with the telecommunication platform by way of a user interface application. The user interface application may include a public user interface and an internal user interface. In certain embodiments, the public user interface displays one or more commercial solicitations during a free telecommunication session by a user. In addition, the public user interface may allow a user to purchase an advertised product through the telecommunication platform.

In one embodiment, the method may synchronize the electronic directory with an existing member tracking system of a sales organization. Finally, the telecommunication platform may connect to one or more gateways enabling the plurality of users to engage in telecommunication sessions with a user that is not included in the plurality of users.

A method is also presented for facilitating management of a multi-level marketing organization. This method contains substantially the same steps as the above method. Additionally, the method may include distributing a peer-to-peer telecommunication platform to a plurality of users. The one or more telecommunication sessions may include one or more of video communication and audio communication. Also, a distributor listed in the electronic directory may manage a multi-level marketing channel by way of the telecommunication platform. Additionally, the method may include recruiting new prospects way of the telecommunication platform. The multi-level marketing channel may include a down-line for the distributor providing mixed audio communication, mixed video communications, and media sharing by way of a media bridge module.

In addition, another method is presented for facilitating management of a multi-level marketing organization with substantially the same steps as the previous methods. However, the method may include distributing a Voice-over-Internet-Protocol (VoIP) telecommunication platform to a plurality of users. Also, the one or more telecommunication sessions may include one or more of mixed audio communication, mixed video communications, and media sharing using a media bridge module.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for facilitating management of a sales organization;

FIG. 2 is a schematic block diagram illustrating one embodiment of a client for facilitating management of a sales organization;

FIG. 3 is a schematic block diagram illustrating one embodiment of an organization backend system for facilitating management of a sales organization;

FIG. 4A is a detailed schematic block diagram illustrating one embodiment of a telecommunication platform for facilitating management of a sales organization;

FIG. 4B is a schematic block diagram illustrating a telecommunication platform communicating with media sources;

FIG. 5A is a schematic block diagram illustrating one embodiment of an electronic directory for facilitating management of a sales organization;

FIG. 5B is a schematic block diagram illustrating another embodiment of an electronic directory for facilitating management of a sales organization; and

FIG. 6 is a schematic block diagram illustrating one embodiment of a method for facilitating management of a sales organization.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

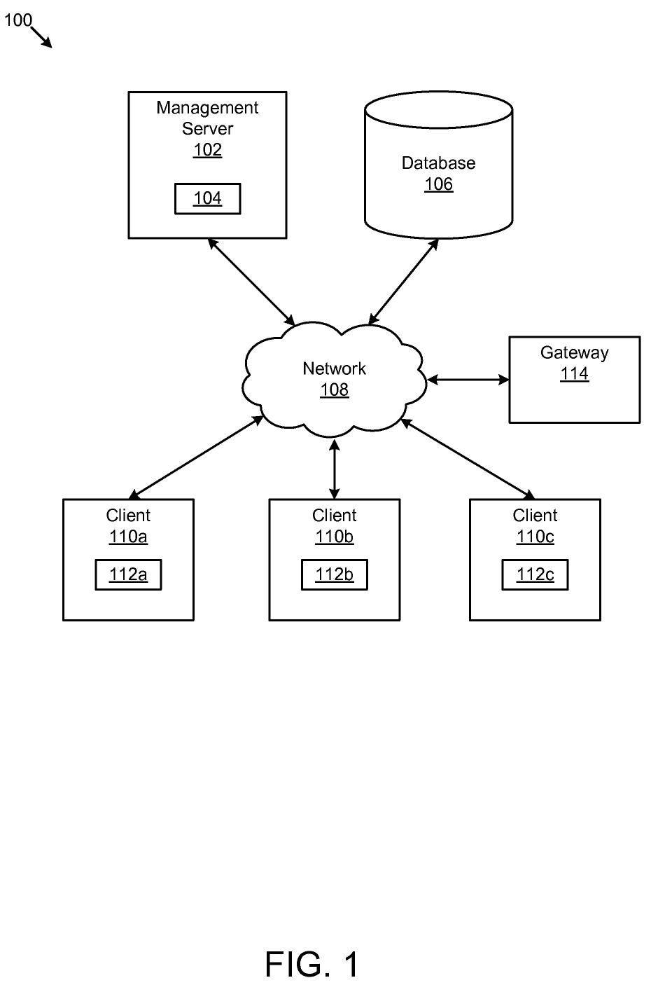

FIG. 1 illustrates one embodiment of a system 100 for facilitating management of a sales organization. The system 100 contains a management server 102, with an organization backend 104, a database 106, a network 108, multiple clients 110 with a telecommunication platform 112, and a gateway 114. The network 108 provides interconnectivity between the components in the system. This network could be a LAN, WAN, the Internet, mobile networks, cellular networks, or any operatively connected combination of these. A person of ordinary skill in this art would be able to select a network interconnection method with minimal effort.

The management server 102 is operatively connected to the network 108. This connection may be accomplished in many ways. The connection type will depend on the networking method selected previously. In one embodiment this is accomplished through a wireless PC networking connection. In another embodiment a fiber optic connection is preferred to increase scalability. As is known by one of ordinary skill in the art, the management server 102 may be a computer running a Windows, Unix, Linux, or similar operating system and capable of operating a software application. Furthermore, the role of the management server 102 and the hosting of the organization backend 104 may be performed by multiple servers 102 or hardware components in communication over the network 108.

The database 106 may store a list of the Organization's members. Such list may contain a collection of names, contact information, and other information about members of the Organization. This list might also be stored in a computer file, on paper, or through any other storage medium. In one embodiment the list is stored in an electronic method (such as a database) that is capable of interfacing with the telecommunication platform 112 and organization backend 104 via electrical signals through the network 108 or a dedicated connection (e.g. shared memory or storage). The database 106 may also store other information used by the organization backend 104.

Multiple clients 110 with telecommunication platforms 112 may also be in communication with the network 108. The telecommunication platform 112 is a client-side application which enables a user, through a client 110 to communicate with other telecommunication platforms 112 on other clients 110. Furthermore, the telecommunication platform 112 may comprise a peer-to-peer telecommunication platform 112 which allows communication in a peer-to-peer fashion. In one embodiment, the telecommunication platform 112 comprises a implements a Voice-over-Internet-Protocol (VoIP) telecommunication platform 112 which uses VoIP to communicate over the internet. Therefore, the client 110 may be a software phone (referred to herein as a soft phone) equipped with the telecommunication platform 112. Furthermore, the telecommunication platform 112 may also interact with the organization backend 104 to receive content, for tracking purposes, and the like.

The telecommunication platform 112 may be implemented using any electronic system that is capable of storing organized information, receiving information to store, retrieving and sending information from storage, and modifying information. In one embodiment this service is implemented using a computer program running on a PC that is operatively connected to a database where information is stored. The program enables the service to encode and decode messages to a plurality of predetermined formats (e.g. XML, SIP, etc.) and enforce business logic, such as access rights that control which users may change information. A client 110a, through the telecommunication platform 112a, may communicate in a peer-to-peer fashion with another client 110b through its telecommunication platform 112b.

In another embodiment, a gateway 114 is connected to the network 108, enabling users to make calls (free or otherwise) to external networks (e.g. cellular networks, the public telephone network, etc). In one embodiment, multiple gateways 114 are connected to the network.

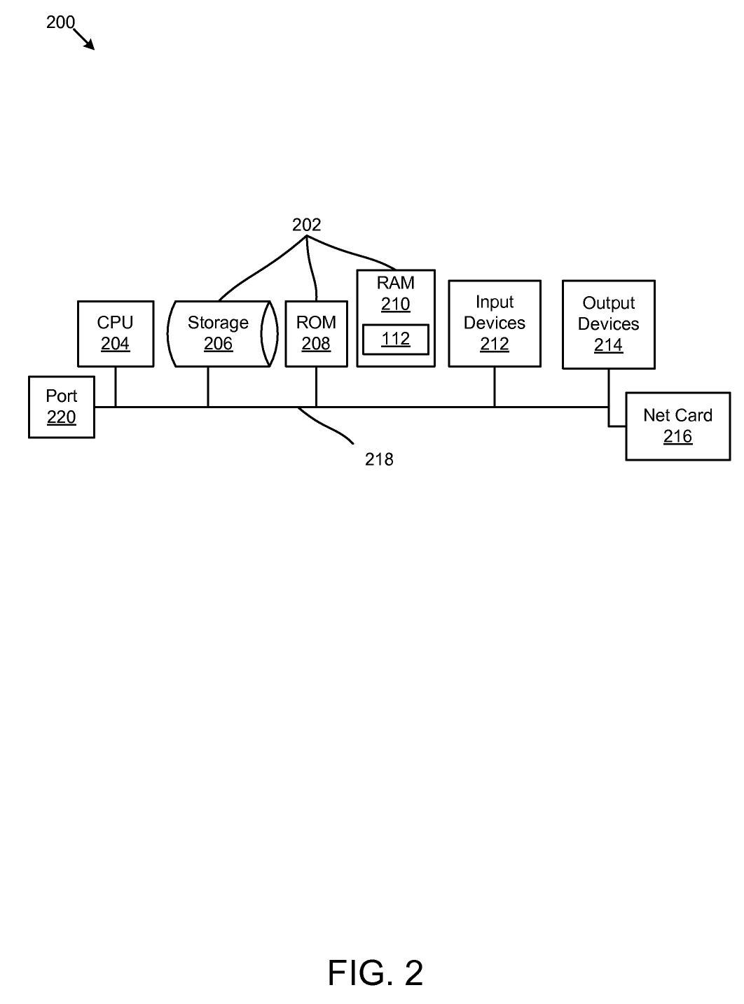

FIG. 2 illustrates one embodiment of a client 200 for facilitating management of a sales organization. The client 200 may comprise one embodiment of a client 110 in FIG. 1. In certain embodiments, the client 200 is an electronic device such as a personal computer. Nevertheless, the device may constitute any type of electronic equipment, including a tablet computer, a PDA, and the like.

The device, hereinafter by way of example is a personal computer and may include a processor or CPU 204. The CPU 204 may be operably coupled to one or more memory devices 202. The memory devices 202 may include a non-volatile storage device 206 such as a hard disk drive or CD ROM drive, a read-only memory (ROM) 208, and a random access volatile memory (RAM) 210.

The personal computer may also include one or more input devices 212 for receiving inputs from a user or from another device. The input devices 212 may include a keyboard, pointing device, touch screen, microphone, optional web cam or other video input source, or other similar human input devices. Similarly, one or more output devices 214 may be provided within or may be accessible from the laptop. The output devices 214 may include a display, speakers, headphones, or the like. A network port such as a network interface card 216 may be provided for connecting to a network.

Within an electronic device such as the personal computer, a system bus 218 may operably interconnect the CPU 204, the memory devices 202, the input devices 212, the output devices 214, the network card 216, and one or more additional ports. The ports may allow for connections with other resources or peripherals, such as printers, digital cameras, scanners, and the like.

Of course, the subsystems may be defined in various manners. In the depicted embodiment, the CPU 204, ROM 208, and RAM 210 may comprise a processing subsystem. The telecommunication platform 112 may be stored on the RAM 210. For example, the telecommunication platform 112 could be built on a PC platform (e.g. personal computer running an operating system such as Windows or Linux) or a cellular telephone (e.g. a cellular telephone with enough processing and storage capabilities to handle the media that will be required from the particular version of the application).

Furthermore, non-volatile storage 206 such as disk drives, CD-ROM drives, DVD drives, and the like may comprise another subsystem. The input devices 212 and output devices 214 may also comprise separate subsystems.

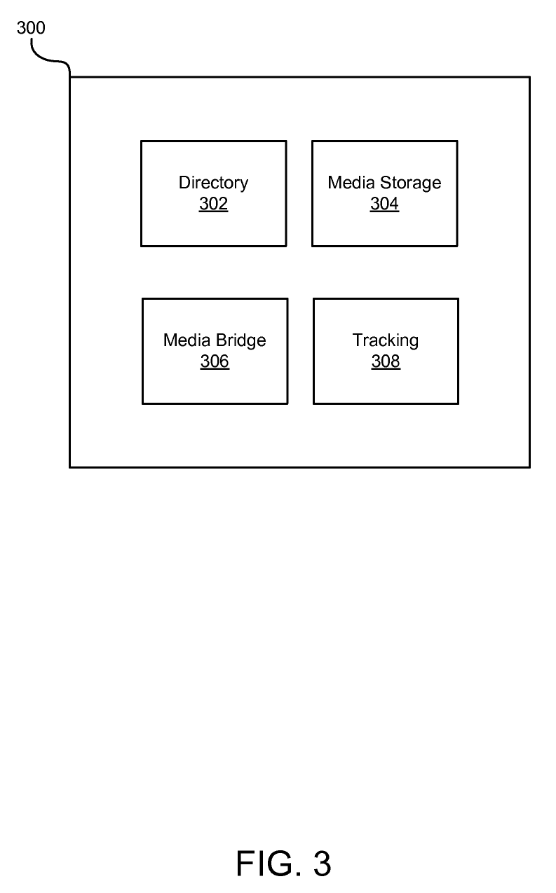

FIG. 3 illustrates one embodiment of an organization backend 300 for facilitating management of a sales organization. The organization backend 300 may comprise one embodiment of the an organization backend 104 in FIG. 1. The organization backend 300 includes a directory module 302, a media storage module 304, a media bridge module 306, and a tracking module 308. These modules may be housed on a single device such as the management server 102, or the modules may be housed on separate electronic devices in communication with the network 108.

In one embodiment, the directory module 302 houses at least information about members of the Organization and the locations of their interfaces on the network. The directory module 302 may also be the means by which many other features and services are enabled, for example the directory module 302 could store information about persons that are not members of the Organization and their locations within the network.

In addition, the directory module 302 may access such information from the database 106. The directory module 302 could house the tracking module 308. Furthermore, the directory module 302 could store user information in an electronic directory about a person's membership in a group within the system, their group leader designation or leader status within that group, their access privileges to various components, and virtually any other information that the system wishes to track. However, it should be noted that this information could be stored in other parts of the system as well.

In one embodiment, the directory module 302 may synchronize the electronic directory with an existing member tracking system of a sales Organization. Therefore, the user information of the Organization's members may be readily used and adapted by the directory module 302 with minimal effort by the Organization.

In one embodiment, the media storage module 304 stores media and replays it at another time. For example, a manager within the Organization may have a message for members of a particular group. Such a manager would be able to store that message on the Media Storage Service 108 and members of that group could play back the message at another time. The media storage module 304 may be housed inside another module, such as the directory module 302 or the media bridge module 306. Furthermore, the media storage module 304 may interface with and store data on the database 106. The media storage module 304 may also be used to store advertisement media. Furthermore, the media storage module 304 may be used as a voicemail system. The media storage module 304 may interface directly with an interface to correspond with external systems, applications, or services. In addition, the media storage module 304 may interface with the media bridge module 306.

To implement the media storage module 304, media storage services are available commercially or could be developed from scratch if desired. Such products may be controlled through SIP, XML, XML-over-SIP, or many other signaling protocols. Examples of media storage services may be provided by Audio Codes of New Jersey or through many other sources. Companies such as Voxeo of Florida provide services that allow media storage services to be combined with voice recognition signaling and voice synthesis.

In one embodiment, a media bridge module 306 provides the system 100 with the ability to mix and distribute media throughout the network. The media bridge module 306 may be housed inside or combined with another module, for example the media storage module 304 or the directory module 302. Very large media conferences with many participants and many clients 110 may require the use of the media bridge module 306. The media bridge module 306 accepts media from the nodes designated for broadcasting (e.g. a live feed to a meeting, or a feed from the Interface of a presenter) and distributes copies of the media to all conference participants.

The media bridge module 306 may also be used to mix and combine signals when more than one broadcasting feed is desired (e.g. mixed audio communication or conferences or mixed video communication such as split screen video conferences, etc.). To implement the media bridge module 306, media bridging products and services are commercially available from a number of manufacturers. Both Voxeo and Audio Codes, mentioned above, provide such products and services. Some of these products and services may be combined with other features, such as voice recognition (e.g. to use voice commands to control conferences) and speech synthesis (e.g. to allow the bridge service to “speak” to the participants).

In one embodiment, the tracking module 308 provides the ability for the system 100 to track and account for all communications that occur between nodes within the system. The tracking module 308 may be housed inside or combined with another module such as the directory module 302. The tracking module 308 may track usage of the telecommunication platform 112 by various users including activating the telecommunication platform, establishing user telecommunication sessions, participating in a user telecommunication session, registering of a user with the multi-level marketing organization, and responding to a commercial solicitation. For example, if a user makes a video conference call with three participants, the tracking module 308 would receive notification signals from the telecommunication platform 112 during each portion of the conference call that inform the tracking module 308 of changes in communications. Thereby, the tracking module 308 is able to keep a log of all media activities for accounting, reference, compensation, performance enhancement, or any other purpose. In addition, the tracking module 308 may provide statistics to a distributor on sales and status in the distributor's down-line.

In one embodiment, the tracking module 308 may be operatively connected to a sales organization compensation system (e.g. database or custom software program) that tracks employee compensation. The sales organization compensation system may be any such system that tracks and assigns compensation for sales employees. Examples of such systems include employee commission systems and multi-level marketing compensation systems which track and assign compensation for sales within a distributor's down-line.

The tracking module 308 may make a connection to the compensation system through an interface, or may go through the network 108. In one embodiment, the tracking module 308 is connected to the compensation system of a network marketing company. This connection may allow usage to be related to channels (also called down-lines) for the purposes of determining a given member's compensation. If the system is used as a recruiting tool, for a network marketing firm or otherwise, then the tracking module 308 may be used to identify which member of the Organization recruited a new user within the system. Furthermore, the tracking module 308 may track new users to the system, whether users are members of the Organization or not, new users of the system who are also new organization members, and new Organization members who are not users of the system. A network marketing Organization may user the tracking module 308 to track the number of prospects, or potential Organization members that join the Organization and/or system and the user responsible for the joining of the prospect.

For example, the tracking module may credit a user when a member of the user's down line responds to an advertisement on the telecommunication platform 112, when a new user joins the system in response to efforts by the user, of when the members of the user's down-line engage in communication activities.

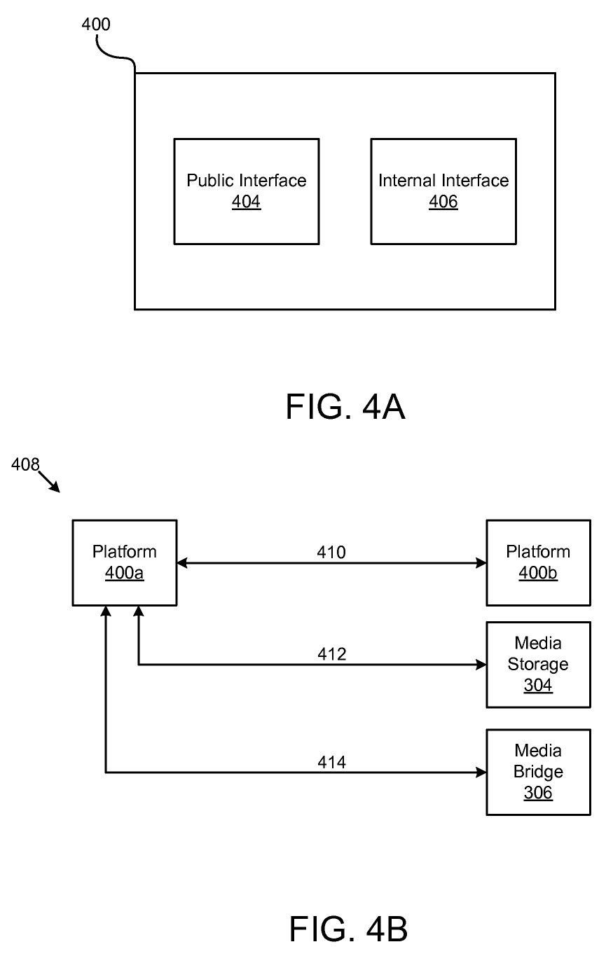

FIG. 4 illustrates one embodiment of a telecommunication platform 400 for facilitating management of a sales organization. The telecommunication platform 400 in FIG. 4 may comprise the telecommunication platform 112 of previous figures and may include a user interface application allowing a user to interact with, and receive communications from the telecommunication platform 112. The user interface application of the telecommunication platform 400 is shown in two versions in one embodiment. The first version is the public version of the interface 404 for use by persons that are not granted special privileges on the system.

The second version of the interface is the internal version 406 and is capable of modifying system settings, viewing restricted media, and performing other internal tasks as defined by access policies stored in the directory module 302. A user may manage the electronic directory through the internal user interface 406 with such tasks as updating user information, group membership, and group leader designation.

One of ordinary skill in the art realizes that both versions of the interface 400 may be contained within the same client software application with certain privileges disabled for public users or may be distributed as separate software applications depending on the level of user. Furthermore, while the telecommunication platform 400 may communicate peer-to-peer with another telecommunication platform 400 on another client, the telecommunication platform 400 may also be in communication with the organization backend 104 to access the electronic directory, obtain media, and for tracking purposes.

Both versions of the telecommunication platform 400 are capable of performing telecommunication sessions. A telecommunication session includes such communications as voice, audio communication or conversations, video communication or conversations, transfer of digital files, text transfer and conversations, presence features, image transfer, electronic media, electronic messages, and other activities. Furthermore, a sales person or network marketing distributor may manage his marketing channel through the telecommunication platform 400. In the case of a network marketing organization, the marketing channel may comprise a multi-level marketing channel. A multi-level marketing channel may include a distributor's down-line, or members of the organization that in a business relationship under the distributor. Therefore, sales and contacts of those in a distributor's down line will influence the compensation and statistics of the distributor. In other sales models, a marketing channel may include other users with whom the sales person has a business relationship with. Such business relationship may include a past sale or regular sales to that user, the sales person's recruitment of the user into the organization, a management relationship, a contact, a new prospect, an associate, a partner, and the like.

The telecommunication platform 400 may be implemented using a number of technologies. In one embodiment the telecommunication platform 400 is running a media communication program on a PC. A common method for enabling such communication is the integration of a Session Initiation Protocol (SIP) based communication stack and an accompanying media transport stack, all of which would be controlled by a control application that interfaces with the user, the services within the system, and the SIP and media transport stacks to coordinate the media experience as desired for the application. One such implementation involves PJSIP as the SIP stack, PJMEDIA as the media transport stack, Microsoft's .Net framework as the controlling application platform (programmed in C# or other .Net compatible languages) with the integrated use of an H.263 (or higher) codec for video transport. As known by one of ordinary skill in the art, the use of SIP in the telecommunication platform 400 allows for much of the communication logic to reside on the client device.

In one embodiment the telecommunication platform 400 allows people that are members of the Organization to talk via voice calls, video conference, text messaging, and other media communications methods without cost. Since the telecommunication platform 400 is capable of providing media transport directly over a public network without an intermediary carrier (like a phone company), the voice telecommunication sessions and other rich media conversations may be provided free of charge. In another embodiment the Organization gives this same free communications experience, via the public interface 404 free of charge.

In another embodiment, the public interface 404 displays advertisements for the Organization (or advertisement space sold through the Organization) in exchange for the free communications. In another embodiment, the Organization uses the public interfaces and their free communications as a tool to recruit new members into the Organization (e.g. a network marketing company may recruit members by giving them a free communications tool). In another embodiment the free communication time expires after a given period of time if the user does not purchase a product, join the Organization, or conduct another activity deemed to be beneficial by the Organization.

In one embodiment, the user may purchase an advertised product through the telecommunication platform 400 by way of the public interface 404. The advertised product may be a product manufactured by or offered through the Organization. In addition, other manufacturers may pay the Organization to advertise their products through the communication platform.

The user may make this purchase in response to commercial solicitation during a free telecommunication session such as a phone call. The user may make the purchase using buttons or navigation as part of the public interface 404 or through an embedded web browser or link to launch a web browser in the interface 404. In addition, the user may engage in a video conference with a distributor to arrange purchase, and other similar methods of contact through the public interface 404.

FIG. 4B illustrates a telecommunication platform 400a communicating with media sources. Specifically, FIG. 4B shows telecommunication platform 400a, connecting to various media exchange sources. The connection 410 between telecommunication platform 400a and telecommunication platform 400b demonstrate that media may flow directly between any two (or more) interfaces in the system. This is enabled by the SIP or other media management protocols as described above.

Concurrently or separately, the telecommunication platform 400a may also exchange media information 412 with the media storage module 304. Concurrently or separately, the user interface application 400a may also exchange media information 414 with the media bridge module 306.

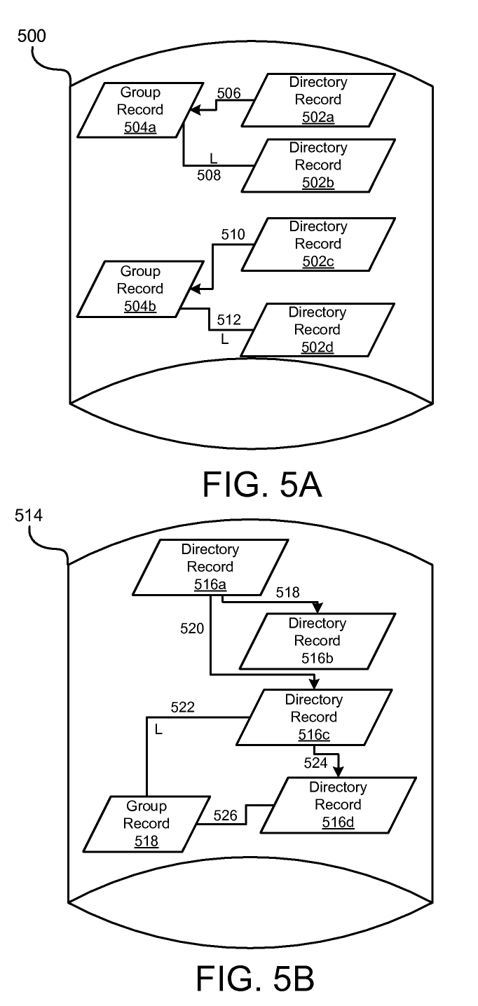

FIG. 5A illustrates one embodiment of an electronic directory 500 for facilitating management of a sales organization. Furthermore, the electronic directory 500 may be one embodiment of directory module 302 storage. In another embodiment, the electronic directory 500 is stored in the database 106 and operationally connected to the directory module 302. FIG. 5A demonstrates the internal organization of this storage for the directory module 302, when not used with a hierarchical structure. A first Directory Record 502a will house information about a user on the system (whether a member of the Organization or not). Various embodiments will store various data, depending on the application and needs of the Organization.

In one embodiment the Directory Record 502a stores a username, a password, a first name, a last name, an address, an email address, relationship to the organization, access privileges information, the user's most recent known IP address, an Internet Uniform Resource Identifier, and other information. The user's most recent known IP address may be updated and tracked using SIP's registration protocols if desired. When any node within the system needs to discover information about a user (also called performing a lookup), the Directory Records 502a are searched for already known information provided by the requesting node (such as a username) and the directory module 302 will reply to the requesting node with requested (not previously known) information (such as the current IP address of the record to begin communications or the password for authentication).

Elements 504a and 504b are Group Records. These records allow users to be placed in groups that will typically correspond to their structure within the organization. The elements 506, 508, 510 and 512 show associative links between a Group Record 504 and a Directory Record 502. These links identify Directory Records 502 as being members of a particular group. Members may be associated with more than one group. Elements 508 and 512 show the “L” symbol next to the link. This signifies that the link is a Leader Link. Leader Links identify a manager or leader (or more than one) within a group and allow those users associated with the Directory Records 502 identified as leaders to have additional control over and access to the group, as defined in policies stored in the directory. Although these records could be stored using numerous methods, a relational database is a good example of a readily available system with the means to provide all of these functions with ease.

FIG. 5B illustrates another embodiment of an electronic directory 514 for facilitating management of a sales organization. This directory and directory records 516 are similar to the directory 500 in FIG. 5A. However, the electronic directory 514 shown in FIG. 5B uses a hierarchical tree structure to store data. In one embodiment this tree structure is used to represent the structure of a network marketing company's channels (also called down-lines). In a hierarchical tree structure data is stored in such a way that each Directory Record 516c has a parent record 516a (except in rare cases, such as the root element 516a) and may have any number of child records 516d associated with it. Such structures are also easily implemented through a relational database or other methods for storing data in an organized manner. The link line 518 demonstrates that Directory Record 516b is a child of Directory Record 516a. The link line 520 demonstrates that Directory Record 516c is also a child of Directory Record 516a and so forth.

As with the non-tree directory 500 in FIG. 5A, the directory 514 uses Group Records 518 for the same purposes. The link line 522 demonstrates that Directory Record 516c is a member of Group Record 518. The accompanying “L” notes that 516c is a group Leader. The link line 526 demonstrates that Directory Record 516d is a member of Group Record 518, no “L” is associated with this link and therefore 516d is not a Leader in the group represented by Group Record 518.

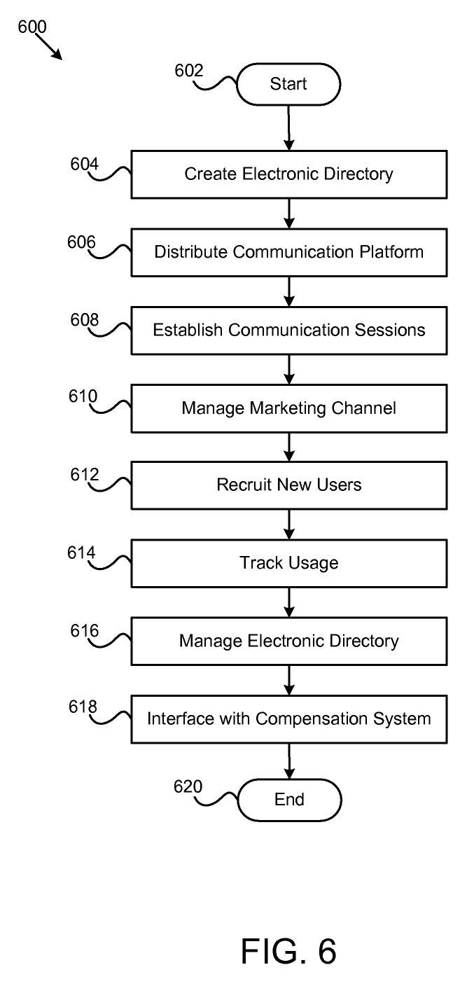

FIG. 6 illustrates one embodiment of a method for facilitating management of a sales organization. The method 600 begins 602 when a network marketing or multi-level marketing organization or the organization management (the “Organization”) creates 604 an electronic directory with multiple directory records and group records. These records may be based on an existing organization membership list. Alternatively, the electronic directory is an existing organization membership list that is used directly such that the creation step is optional in certain embodiments. In addition, these records may be transferred from the Organization's existing membership records through electronic means.

The Organization then distributes 606 a telecommunication platform 400 to multiple users to interface with the electronic directory. A copy of the platform 400 may be distributed on a compact disk, a USB drive, a headset or other device for telephonic use, available for download on the internet, and the like. Next, the Organization establishes 608, by way of the telecommunication platform 400, one or more telecommunication sessions for the users. These telecommunication sessions may include exchanging electronic media, video, audio, electronic messages, and digital files.

Next, a sales person listed in the electronic directory manages 610 a marketing channel by way of the telecommunication platform 400. This marketing channel may include other users having a business relationship to the sales person. In the case of a multi-level marketing organization, the marketing channel is a sales person's, (a distributor's) down-line. This down-line consists of the users represented by child Directory Records 516c.

The Organization then recruits 612 new users of the telecommunication platform 400 and new organization members, or prospects, by way of the telecommunication platform 400. The telecommunication platform 400 may solicit for new users and new organization members in exchange for establishing telecommunication sessions on the telecommunication platform 400 free of charge. For example, a user may have the ability to make free telephone calls over the telecommunication platform 400 in exchange to viewing electronic advertisements. Some advertisements may include invitations to join the Organization or invitations to purchase products from the Organization or through the Organization member that distributed the copy of the telecommunication platform 400 to the user.

Next, the Organization tracks 614 the usage of the telecommunication platform 400 by the users. This usage tracked by the platform may include activating the telecommunication platform 400, establishing user telecommunication sessions, participating in a user telecommunication session, registering of a user with the organization, and responding to a solicitation. The organization then manages 616 the electronic directory which includes such tasks as updating user information, group membership, and group leader designation.

Finally, the Organization interfaces 618 with a sales organization compensation system through the telecommunication platform 400. This may include crediting a user in response to members of the marketing channel of the user using the telecommunication platform 400, responding to advertisements, purchasing products through the platform, and the like. Then, the method 600 ends 620.

One example of this method and system in operation involves a network marketing company, Company A, that is implementing the system to enhance communications, increase revenues, and recruit new members. This is only a single implementation example and should not be construed to limit the scope of the invention to this operational example's specifics.

Company A is a network marketing company. Currently, it is using primarily traditional telephone communications and email to communicate internally, with distributors, and with potential distributors/customers. While an occasional video or audio conference may be arranged for a particular purpose, such an event uses systems separate from their daily communications systems and is expensive, since it is provided by an external carrier.

Company A will implement this system in order to centralize their communications and use the system to enhance business functions as explained above. First Company A will develop the telecommunication platform 400 for both Internal and Public use. The Internal version will focus more on internal business communications and team management and the public version will focus mostly on being a user friendly way to communicate using a variety of media types and with minimal or no expense.

Company A has selected to build a Microsoft Windows based application that will run on personal computers. The company will build the interface to allow easy point-and-click communications with audio, video, text, or other media. The directory module 302 will be built to support this interface, track users and assist them in finding each other.

Company A has decided to use the hierarchical tree structured directory to match their internal channels of communications. Each of their members will be able to see and easily manage his or her channel (or down-line) through the telecommunication platform 400. Managers will be able to create media content (such as a video) and send it to their down-line via the media storage module 304. Users will also be able to use this service to store voice, video, or text messages for each other when a real-time media conversation is not possible.

Company A will also be using the system to centralize their media conferencing. The media bridge module 306 will allow large groups of people to view conferences or meetings. This will allow company A to have motivational meetings and media activities for a fraction of the cost of bringing their distributors to a physical location for meetings.

The scalability of the system allows managers and other decision makers to use a single tool for a large range of meetings from small meetings involving only a few users to meetings that involve the entire organization. The real-time two way mode of media will allow users to participate in meetings, as opposed to simply watching or listening. The combination of the Interface Applications for each user, the media bridge module 306, and the media storage module 304 give Company A enough flexibility that meeting formats may be modified according to the needs of a particular group or task.

Users operating the telecommunication platform 400 may use a phone device or headset provided by Company A in combination with their PC and a web camera or other video device to see and hear other users on the system.

Members of Company A may give the telecommunication platform 400 (including the user interface application) to friends, family, and others that may wish to communicate free of charge. Users on the platform 400 will be able to call other users, phone numbers, and other destinations with their telecommunication platform 400. This service is provided free-of-charge to the end users. However, Company A does display advertisement media before, after or during free conversations. Additionally, the member that distributed the device to the user will use the telecommunication platform 400 as a means for introducing the new user to Company A and their products with the intent to either recruit the new user into the organization or sell the user products or services made by Company A. Products or Services from Company A may be purchased through the Interface Application.

The tracking module 308 will track the new users and their usage as well as associate them with a member of Company A. Interface usage, sales, and recruiting activities will be tracked and used as a part of the method for determining the compensation of the members of Company A.

Using Internet Uniform Resource Identifiers in the directory module 302 allows users to have a single URI (e.g. bob@CompanyA.com) for their email, phone, video, fax, text, and other messaging locator.

The use of the telecommunication platform 400 may enhance the network marketing channels by interconnecting networks of distributors, enhancing communications between distributors, enhancing communications with people outside of the organizations, building new revenue streams, creating new ways to introduce new potential customers or distributors to a network marketing system or its products, and providing other benefits to the network marketing organization, the organization's distributors, and customers of the organization.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for facilitating management of a sales organization, the method comprising:
distributing a telecommunication platform to a plurality of users, the telecommunication platform configured to interface with an electronic directory comprising a plurality of directory records and group records, each directory record comprising user information, each group record configured to indicate user group membership and one or more group leaders;
establishing, by way of the telecommunication platform, one or more telecommunication sessions for the plurality of users, the one or more telecommunication sessions exchanging voice, video, audio, electronic messages, electronic media, and digital files;
a sales person listed in the electronic directory managing a marketing channel by way of the telecommunication platform, the marketing channel comprising at least one user of the plurality of users having a business relationship to the sales person; and
recruiting new users of the telecommunication platform and new organization members by way of the telecommunication platform, the telecommunication platform soliciting for new users and new organization members in exchange for establishing telecommunication sessions on the telecommunication platform.

2. The method of claim 1, further comprising tracking usage of the telecommunication platform by the users, the usage comprising activating the telecommunication platform, establishing user telecommunication sessions, participating in a user telecommunication session, registering of a user with the organization, and responding to a solicitation.

3. The method of claim 1, further comprising managing the electronic directory, wherein managing comprises updating one or more of user information, group membership, and group leader designation.

4. The method of claim 1, further comprising interfacing with a sales organization compensation system, wherein interfacing comprises crediting a user in response to members of the marketing channel that belongs to the user using features of the telecommunication platform.

5. The method of claim 1, wherein the electronic directory comprises a hierarchical tree structure configured to represent a plurality of marketing channels for the sales organization, the hierarchical tree structure comprising parent directory records and child directory records.

6. The method of claim 1, further comprising enabling user interaction with the telecommunication platform by way of a user interface application, the user interface application comprising a public user interface and an internal interface.

7. The method of claim 4, wherein the public user interface is configured to display one or more commercial solicitations during a telecommunication session of a user that is established free of charge.

8. The method of claim 6, wherein the user interface application is further configured to allow a user to purchase an advertised product through the telecommunication platform.

9. The method of claim 1, further comprising synchronizing the electronic directory with an existing member tracking system of a sales organization.

10. The method of claim 1, wherein the telecommunication platform is connected to one or more gateways configured to enable the plurality of users to engage in telecommunication sessions with a user that is not included in the plurality of users.

11. A method for facilitating management of a multi-level marketing organization, the method comprising:
creating an electronic directory comprising a plurality of directory records and group records, each directory record comprising user information, each group record configured to indicate user group membership and one or more group leaders;
distributing a peer-to-peer telecommunication platform to a plurality of users, the peer-to-peer telecommunication platform configured to interface with the electronic directory;
establishing, by way of the peer-to-peer telecommunication platform, one or more telecommunication sessions for the plurality of users, the one or more telecommunication sessions comprising one or more of video communication and audio communication;
a distributor listed in the electronic directory managing a multi-level marketing channel by way of the peer-to-peer telecommunication platform, the multi-level marketing channel comprising a down-line for the distributor;
recruiting new users of the peer-to-peer telecommunication platform and prospects by way of the peer-to-peer telecommunication platform, the peer-to-peer telecommunication platform soliciting for new users and prospects in exchange for establishing voice telecommunication sessions on the peer-to-peer telecommunication platform free of charge; and tracking usage of the peer-to-peer telecommunication platform by the users, the usage comprising activating the peer-to-peer telecommunication platform, establishing user telecommunication sessions, participating in a user telecommunication session, registering of a user with the multi-level marketing organization, and responding to a solicitation.

12. The method of claim 11, further comprising managing the electronic directory, wherein managing comprises updating one or more of user information, group membership, and group leader designation.

13. The method of claim 11, further comprising interfacing with a multi-level marketing organization compensation system, wherein interfacing comprises crediting a user in response to members of the multi-level marketing channel that belongs to the user using features of the peer-to-peer telecommunication platform.

14. The method of claim 11, wherein the electronic directory comprises a hierarchical tree structure configured to represent a plurality of marketing channels for the multi-level marketing organization, the hierarchical tree structure comprising parent directory records and child directory records.

15. The method of claim 11, further comprising enabling user interaction with the peer-to-peer telecommunication platform by way of a user interface application, the user interface application comprising a public user interface and an internal user interface, the public user interface configured to display one or more commercial solicitations during a telecommunication session of a user that is established free of charge.

16. The method of claim 11, further comprising providing mixed audio communication, mixed video communications, and media sharing by way of a media bridge module.

17. A method for facilitating management of a multi-level marketing organization, the method comprising:
creating an electronic directory comprising a plurality of directory records and group records, each directory record comprising user information, each group record configured to indicate user group membership and one or more group leaders;
distributing a Voice-over-Internet-Protocol (VoIP) telecommunication platform to a plurality of users, the VoIP telecommunication platform configured to interface with the electronic directory;
establishing, by way of the VoIP telecommunication platform, one or more telecommunication sessions for the plurality of users, the one or more telecommunication sessions comprising one or more of mixed audio communication, mixed video communications, and media sharing using a media bridge module;
a distributor listed in the electronic directory managing a multi-level marketing channel by way of the VoIP telecommunication platform, the multi-level marketing channel comprising a down-line for the distributor;
recruiting new users of the VoIP telecommunication platform and prospects by way of the VoIP telecommunication platform, the VoIP telecommunication platform soliciting for new users and prospects in exchange for establishing telecommunication sessions on the VoIP telecommunication platform free of charge;
tracking usage of the VoIP telecommunication platform by the users, the usage comprising activating the VoIP telecommunication platform, establishing user telecommunication sessions, participating in a user telecommunication session, registering of a user with the organization, and responding to a solicitation; and
interfacing with a sales organization compensation system, wherein interfacing comprises crediting a user in response to members of the marketing channel that belongs to the user using features of the VoIP telecommunication platform.

18. The method of claim 17, further comprising managing the electronic directory, wherein managing comprises updating one or more of user information, group membership, and group leader designation.

19. The method of claim 17, wherein the electronic directory comprises a hierarchical tree structure configured to represent a plurality of marketing channels for the multi-level marketing organization, the hierarchical tree structure comprising parent directory records and child directory records.

20. The method of claim 17, further comprising enabling user interaction with the VoIP telecommunication platform by way of a user interface application, the user interface application comprising a public user interface and an internal user interface, the public user interface configured to display one or more commercial solicitations during a telecommunication session of a user that is established free of charge and configured to allow a user to purchase an advertised product through the VoIP telecommunication platform.
